(19) United States
(12) Patent Application Publication
(10) Pub. No.: US 2023/0331269 A1
(43) Pub. Date: Oct. 19, 2023

(54) TRAIN JOLT DETERMINATION SYSTEM

(71) Applicant: WEST JAPAN RAILWAY COMPANY, Osaka (JP)

(72) Inventors: Atsushi MATSUDA, Osaka (JP); Kohei TANAKA, Osaka (JP)

(73) Assignee: WEST JAPAN RAILWAY COMPANY, Osaka (JP)

(21) Appl. No.: 18/131,961

(22) Filed: Apr. 7, 2023

(30) Foreign Application Priority Data
Apr. 14, 2022 (JP) 2022-066824

(51) Int. Cl. B61L 27/53; G06T 7/70; G06T 7/20; B61K 9/08

(52) U.S. Cl. CPC B61L 27/53; G06T 7/70; G06T 7/20; B61K 9/08; G06T 2207/30252

(57) ABSTRACT

A train jolt determination system includes: a portable terminal capable of being held in a train and configured to acquire position information on the train, detect the acceleration of the train, and capture an image of the scene around the train; a storage section configured to associate the position information, acceleration information indicative of a detection result of the acceleration, and image information indicative of the scene and store the position information, the acceleration information, and the image information; and a jolt amount calculation section configured to calculate an amount of jolting of the body based on the acceleration information. In a case where the body is determined to have jolted based on the amount of jolting, position information associated with acceleration information used for the determination of jolting is supplemented with image information associated with the acceleration information, and a position where the body has jolted is estimated.

### CROSS REFERENCE TO RELATED APPLICATIONS

This application is based on and claims priority under 35 U.S.C. Section 119 to Japanese Patent Application No. 2022-066824 filed on Apr. 14, 2022, the entire content of which is incorporated herein by reference.

### BACKGROUND OF THE INVENTION

### 1. Field of the Invention

This disclosure relates to a train jolt determination system for determining the jolting of a train.

### 2. Description of the Related Art

In order to secure safe running of a train, a railroad company monitors the behavior of a body of the train during the running of the train. One of the behavior of the body is jolting of the body. In the related art, a jolt caused in the body is measured by a jolt meter provided in the train. A technology to measure such a jolt of a train is disclosed in WO2018/110553 described below, for example.

WO2018/110553 describes a jolt measurement system. The jolt measurement system includes a portable jolt meter and a jolt information measuring apparatus. In a state where the jolt information measuring apparatus is fixed to a window or a driver's seat in a movable body, a lateral jolt value (lateral acceleration) in a right-left direction as the width direction of the movable body based on the advancing direction of the movable body, and a vertical jolt value (a vertical acceleration) in an up-down direction perpendicular to both the advancing direction and the right-left direction are measured. The portable jolt meter is constituted by a smartphone and acquires position information on the portable jolt meter based on GPS signals from a positioning satellite. The portable jolt meter includes a display that displays jolt information indicative of the degree of jolt of the movable body and a measurement time when the jolt information is acquired, and in a case where a measurement time is selected by an operator, the display of the portable jolt meter displays surrounding video image information acquired at the measurement time.

### SUMMARY OF THE INVENTION

A railroad (including tracks) is provided over a wider range by a railroad company, and a range where jolting is measured becomes wider in accordance with the length of the railroad. In order to measure jolting efficiently over such a wide range, a lot of jolt information measuring apparatuses for measuring the jolt value of the body are required. However, the jolt information measuring apparatus is very expensive, and therefore, a cost reduction is desired. Further, in the technology described in WO2018/110553, position information on the portable jolt meter is acquired based on GPS signals from the positioning satellite, so that a measurement result by the jolt information measuring apparatus is associated with the position information. However, in a case where a train is running at the foot of a mountain, through a tunnel, or the like, for example, the portable jolt meter may not be able to acquire GPS signals from the positioning satellite, and a measurement result from the jolt information measuring apparatus may not be able to be associated with the position information on the portable jolt meter appropriately. Accordingly, it may be difficult to specify at which position the measurement result of jolt is acquired.

Embodiments of the present invention provide a train jolt determination system that can specify a position (location) where jolting occurs, with a low-cost configuration.

A train jolt determination system according to this disclosure is a train jolt determination system for determining jolting of a train and includes: a portable terminal capable of being held in the train and including at least a position information acquisition section configured to acquire position information indicative of a position of the train, an acceleration sensor configured to detect an acceleration caused in a body of the train, and an imaging section configured to capture an image of a scene around the train; a storage section configured to associate, with each other, the position information, acceleration information indicative of a detection result of the acceleration, and image information indicative of the scene around the train and store the position information, the acceleration information, and the image information; a jolt amount calculation section configured to calculate an amount of jolting of the body based on the acceleration information; a jolt determination section configured to determine, based on the amount of jolting, whether or not the body has jolted; and a jolt position estimation section configured to, in response to the jolt determination section determining that jolting has occurred, supplement position information associated with acceleration information used for the determination of jolting with image information associated with the acceleration information and estimate a position where the body has jolted.

In this case, the acquisition of position information on the train, the detection of an acceleration caused in the body of the train, and the acquisition of an image including a moving image and sound around the train can be performed by one portable terminal, so that the portable terminal can be easily held in the train and also manufactured at a low cost. Further, the amount of jolting can be calculated based on the detected acceleration, and a location where the body has jolted can be specified by use of image information as well as position information. As a result, even in a tunnel or the like in which no GPS signal is receivable, for example, it is possible to specify, with accuracy, the position where jolting has occurred, by supplementing the position information with image information or acceleration information. Further, when another device (e.g., a server) different from the portable terminal is configured to calculate the amount of jolting, determine whether or not jolting has occurred, or estimate the position where the jolting has occurred, the portable terminal held in the train has only to acquire position information, detect an acceleration, and capture images of the scene around the train, and therefore, it is not necessary to use a high-performance device. Accordingly, the train jolt determination system can be achieved at a low cost.

Further, the train jolt determination system according to one aspect can be configured to include: a position information determination section configured to, in response to the jolt determination section determining that jolting has occurred, determine whether the position information associated with the acceleration information used for the determination of jolting is appropriate or not, based on the image information associated with the position information and image information associated with previous position information acquired just before the position information; a most-recent position determination section configured to, in response to the position information being determined not to be appropriate, determine appropriate most recent position information before a first point at which the position information determined not to be appropriate has been acquired, based on at least either of the image information and the acceleration information; and a running speed calculation section configured to calculate a running speed of the body in a period during which two consecutive pieces of position information are acquired, the period being included in a period from the first point to a second point at which the most recent position information has been acquired. The jolt position estimation section can be configured to estimate a position of the jolting determined to have occurred by the jolt determination section, based on the most recent position information determined to be appropriate and the running speed.

In this case, even in a case where the position information acquisition section cannot acquire position information appropriately like a case where the train is running through a tunnel, for example, the running speed calculation section calculates the running speed of the train based on image information or acceleration information, so that a position (location) of jolting determined to have occurred can be estimated based on appropriate position information acquired at the entrance or exit of the tunnel and the calculated running speed.

Further, the train jolt determination system according to one aspect can be configured to include a cancellation section configured to, in a case of the jolt determination section determining whether or not jolting has occurred by use of pieces of position information, pieces of acceleration information, and pieces of image information acquired from a plurality of trains, cancel a determination result made by the jolt determination section to indicate the occurrence of jolting in the body, in response to a smaller amount of jolting than a preset value being detected only a preset number of times in a predetermined range including the position estimated by the jolt position estimation section.

In this case, a determination result indicating that jolting has occurred due to false detection of acceleration or false determination of the amount of jolting due to a curved area in railroad tracks, or the like can be canceled. Accordingly, it is possible to enhance the accuracy of the train jolt determination system for determination of whether or not jolting has occurred.

Further, the train jolt determination system according to one aspect may be configured to include a maintenance timing calculation section configured to, in a case of the jolt determination section determining whether or not jolting has occurred by use of pieces of position information, pieces of acceleration information, and pieces of image information acquired from a plurality of trains, calculate, based on degree of increase in the amount of jolting, a maintenance timing of running equipment in a predetermined range including the position estimated by the jolt position estimation section, in response to the amount of jolting of the body having an increase tendency to increase gradually in the predetermined range.

In this case, since it is possible to calculate a maintenance timing of the running equipment based on the amount of jolting, it is possible to reduce labor for an operator to visit an actual place to check whether or not the running equipment requires maintenance, for example. Accordingly, the efficiency of maintenance activities can improve.

Further, the train jolt determination system according to one aspect may include: a jolt factor estimation section configured to estimate a factor that has caused the body to jolt from image information including a scene at a position of the jolting determined to have occurred in the body by the jolt determination section; and a notification section configured to exhibit the factor estimated by the jolt factor estimation section in the image information.

In this case, a factor that has caused jolting can be estimated based on the state of a place where jolting has occurred, included in image information, or sound during running in the place, for example. Further, by causing the jolt factor estimation section to implement a machine learning model configured to autonomously specify a state that can be a factor that has caused jolting based on images or sound, for example, it is possible to extract only a jolting area related to the maintenance of the running equipment, thereby making it possible to perform maintenance activities efficiently.

### BRIEF DESCRIPTION OF THE DRAWINGS

FIG. 1 is a block diagram illustrating a configuration of a train jolt determination system;

FIG. 2 is an example in which a portable terminal is held;

FIG. 3 is an explanatory view on the acquisition of position information, acceleration information, and image information;

FIG. 4 is a view illustrating a detection result of acceleration;

FIG. 5 is an explanatory view on position information in a case of running through a tunnel;

FIG. 6 is an explanatory view on the supplement of position information;

FIG. 7 is an explanatory view on the cancellation of a determination result;

FIG. 8 is an explanatory view on the calculation of a maintenance timing;

FIG. 9 is an example of the image information; and

FIG. 10 is an example of the image information.

### DESCRIPTION OF THE PREFERRED EMBODIMENTS

A train jolt determination system according to this disclosure has a function to determine the jolting of a train. A train indicates a vehicle that runs along a railroad track and corresponds to an electric train configured to run by using electricity as power or a diesel train configured to run by using, as power, the output from an internal combustion engine or a steam engine. Jolting indicates a bumping motion. Accordingly, the jolting of a train means that a vehicle running along a railroad track moves in a bumping motion. The train jolt determination system determines such a bumping motion of a vehicle running along a railroad track.

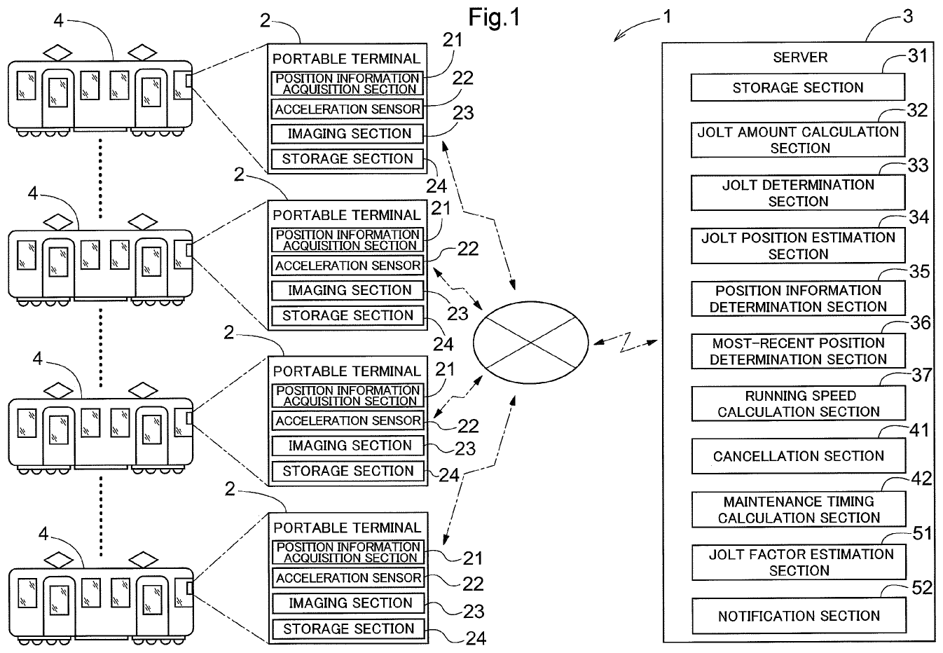

A train jolt determination system 1 of the present embodiment will be described below. FIG. 1 is a block diagram schematically illustrating a configuration of the train jolt determination system 1. In the present embodiment, in the train jolt determination system 1, various functional sections constituting the train jolt determination system 1 are provided dispersedly in portable terminals 2 and a server 3 communicable with each other via a network.

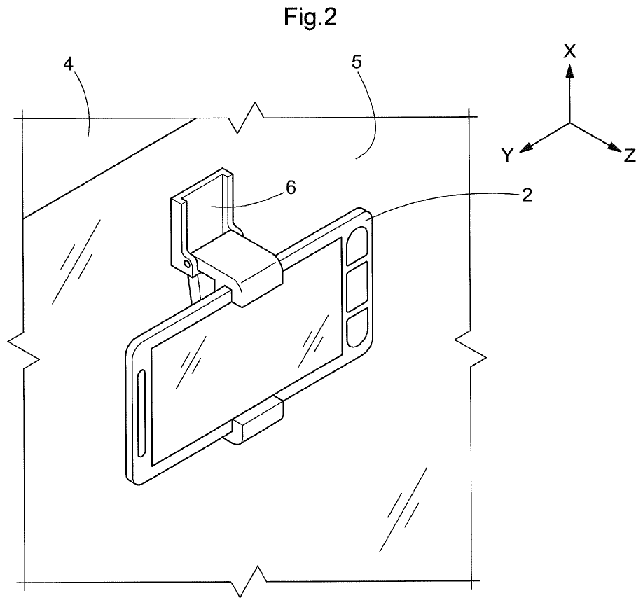

The portable terminals 2 are each held in a corresponding one of a plurality of electric trains 4 (an example of the “train”) and can be constituted by a smartphone, for example. As illustrated in FIGS. 1, 2, the portable terminal 2 should be provided in a place where the area ahead of the lead vehicle of the electric train 4 in its advancing direction is observable (in the example of FIG. 2, the portable terminal 2 is held by a holder 6 attached to a front window 5). The portable terminal 2 includes a position information acquisition section 21, an acceleration sensor 22, an imaging section 23, and a storage section 24 as illustrated in FIG. 1. The server 3 is provided in a garage for the electric trains 4 or a maintenance depot where the electric trains 4 are subjected to maintenance, for example. The server 3 includes a storage section 31, a jolt amount calculation section 32, a jolt determination section 33, a jolt position estimation section 34, a position information determination section 35, a most-recent position determination section 36, a running speed calculation section 37, a cancellation section 41, a maintenance timing calculation section 42, a jolt factor estimation section 51, and a notification section 52. Functional sections provided in the portable terminal 2 and the server 3 are each constituted by hardware, software or both of them with a CPU as a core member so as to perform a process for determination of the jolting of the electric train 4. Note that the present embodiment deals with the electric train 4 as an example of the train, but the train is not limited to the electric train 4, provided that the train is a vehicle running along a railroad track. Further, some functional sections among the functional sections of the server 3 may be dispersedly provided in other apparatuses or may be installed in the portable terminal 2.

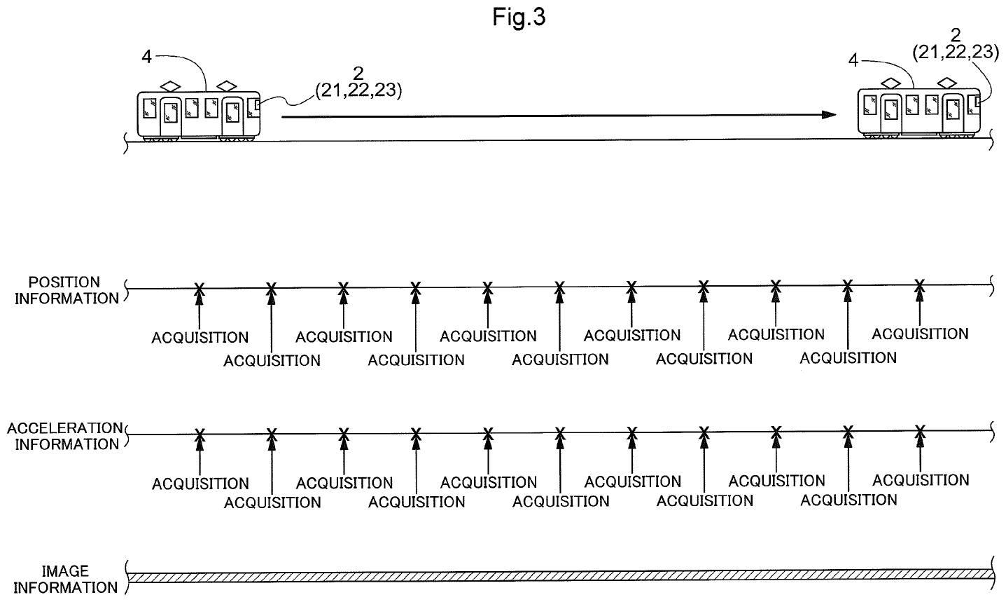

The position information acquisition section 21 acquires position information indicative of the position of the electric train 4. The position information acquisition section 21 is constituted by use of a satellite positioning module as a GNSS module and is configured to receive GPS signals or GNSS signals (referred to as “GPS signals” in the present embodiment) from artificial satellites and acquire position information including latitude information and longitude information on the position information acquisition section 21 based on the GPS signals thus received. In the present embodiment, the position information acquisition section 21 is provided in the portable terminal 2 as described above, and the portable terminal 2 is held in the electric train 4. Accordingly, the position information acquisition section 21 is provided in the electric train 4, so that the position information acquired by the position information acquisition section 21 is information indicative of the position of the electric train 4. The position information acquisition section 21 acquires position information at every predetermined time, as illustrated in FIG. 3. The position information thus acquired is sequentially stored in the storage section 24 of the portable terminal 2 together with time information indicative of the time when the position information is acquired. Note that the position information may include altitude information, and it is also possible to find the gradient of a railroad track where the electric train 4 runs, based on a change in the altitude information, for example.

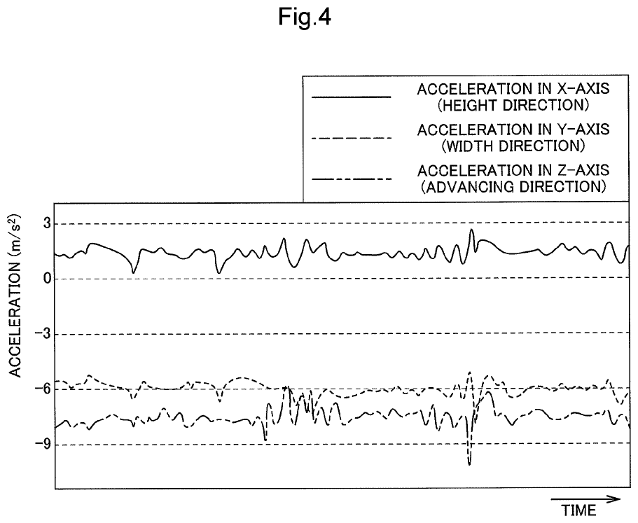

Referring back to FIG. 1, the acceleration sensor 22 detects acceleration to be caused in a body of the electric train 4. The acceleration sensor 22 detects respective accelerations along three axes (an X-axis, a Y-axis, a Z-axis) perpendicular to each other and acquires the accelerations as acceleration information. Here, in the present embodiment, the acceleration sensor 22 is provided in the portable terminal 2 as described above, and the portable terminal 2 is held in the electric train 4. Accordingly, the acceleration sensor 22 is provided in the electric train 4, so that the acceleration information acquired by the acceleration sensor 22 is information indicative of acceleration caused in the body of the train. In the present embodiment, as illustrated in FIG. 2, the portable terminal 2 is provided such that the Y-axis of the acceleration sensor 22 is along the width direction of the body, the Z-axis of the acceleration sensor 22 is along the advancing direction of the body, and the X-axis of the acceleration sensor 22 is along the height direction of the body, the height direction being perpendicular to both the advancing direction and the width direction. Hereby, the acceleration sensor 22 can detect the accelerations along the width direction of the body, the advancing direction of the body, and the height direction of the body as illustrated in FIG. 4. The acceleration sensor 22 acquires acceleration information at every predetermined time as illustrated in FIG. 3. The acceleration information thus acquired is sequentially stored in the storage section 24 of the portable terminal 2 together with time information indicative of the time when the acceleration information is acquired. Note that, as described above, the position information acquisition section 21 also acquires position information at every predetermined time, but the timing when the acceleration sensor 22 acquires acceleration information may be the same as or different from the timing when the position information acquisition section 21 acquires position information.

The imaging section 23 captures images of the scene around the electric train 4. A camera configured to take a picture of a subject corresponds to the imaging section 23. In the present embodiment, the subject corresponds to the scene around the electric train 4. The imaging section 23 acquires, as image information, a captured image obtained by image capture. Here, in the present embodiment, the imaging section 23 is provided in the portable terminal 2 as described above. Further, the portable terminal 2 is provided in a place where the area ahead of the lead vehicle of the electric train 4 in the advancing direction is observable but is provided particularly in a state where the optical axis of the imaging section 23 faces forward in the advancing direction of the electric train 4. Accordingly, the optical axis of the imaging section 23 is directed toward the advancing direction of the electric train 4 so that the imaging section 23 is provided in a place where the area ahead of the lead vehicle of the electric train 4 in the advancing direction is observable, and hereby, image information acquired by the imaging section 23 is information indicative of the area ahead of the electric train 4 in the advancing direction and its surrounding scene. In the present embodiment, the imaging section 23 acquires image information constituted by a continuous moving image as illustrated in FIG. 3. The image information thus acquired is sequentially stored in the storage section 24 of the portable terminal 2 together with time information indicative of the time when image capture is started. In the present embodiment, since the image information is a moving image, only time information indicative of an image-capture start time is stored together with the image information. Note that the imaging section 23 may be configured to acquire image information constituted by a still image at every predetermined time, instead of the moving image.

Referring back to FIG. 1, the position information, the acceleration information, and the image information are each stored in the storage section 24 together with its corresponding time information as described above. These pieces of information are stored continuously every time they are acquired while the electric train 4 is running. In the present embodiment, each information stored in the storage section 24 is transmitted to the server 3 via the network when the electric train 4 returns to the garage or the maintenance depot. Accordingly, the storage section 24 sequentially stores the position information, the acceleration information, and the image information acquired during the running of the electric train 4. It is needless to say that the electric train 4 may be configured to transmit these pieces of information during the transport of passengers, and for example, these pieces of information may be transmitted to the server 3 from the portable terminal 2 via the network at a predetermined time (e.g., at every hour). Note that it is preferable that old data be overwritten with new data at a point when the memory capacity of the portable terminal 2 reaches a predetermined amount.

As described above, the position information, the acceleration information indicative of an acceleration detection result, and the image information indicative of the surrounding scene are transmitted to the server 3 from the portable terminal 2 via the network. The server 3 stores, in the storage section 31, the position information, the acceleration information, and the image information transmitted from the portable terminal 2 such that the position information, the acceleration information, and the image information are associated with each other. As described above, the storage section 24 of the portable terminal 2 stores the position information, the acceleration information, and the image information together with their corresponding pieces of time information. The storage section 31 of the server 3 may associate the position information, the acceleration information, and the image information with each other based on their corresponding pieces of time information and stores these pieces of information, or the storage section 31 may associate pieces of information having the same time information with each other and store the pieces of information.

The jolt amount calculation section 32 calculates the amount of jolting of the body based on acceleration information. As described above, in the present embodiment, the acceleration sensor 22 detects accelerations along the advancing direction of the body, the width direction of the body, and the height direction of the body. The acceleration information includes information indicative of the accelerations in these three directions. The amount of jolting of the body indicates an amount by which the body has jolted and corresponds to respective amounts by which the body has jolted in the advancing direction of the body, the width direction of the body, and the height direction of the body. The amount of jolting can be calculated based on respective accelerations (or the amounts of change in the accelerations) in the advancing direction of the body, the width direction of the body, and the height direction of the body and respective times when the accelerations occur. Accordingly, the jolt amount calculation section 32 calculates the amount of jolting in the advancing direction of the body based on the acceleration in the advancing direction of the body and a time when the acceleration occurs, calculates the amount of jolting in the width direction of the body based on the acceleration in the width direction of the body and a time when the acceleration occurs, and calculates the amount of jolting in the height direction of the body based on the acceleration in the height direction of the body and a time when the acceleration occurs.

The jolt determination section 33 determines whether the body has jolted or not, based on the amount of jolting. The amount of jolting is calculated by the jolt amount calculation section 32 and is transmitted to the jolt determination section 33. Whether the body has jolted or not may be determined as follows. That is, for example, the jolt determination section 33 stores, in advance, a threshold set in accordance with the amount of jolting based on which the body is determined to have jolted, and compares the amount of jolting calculated by the jolt amount calculation section 32 with the threshold to determine whether the body has jolted or not. More specifically, in a case where the amount of jolting calculated by the jolt amount calculation section 32 is larger than the threshold set in advance, the jolt determination section 33 should determine that the body has jolted, and in a case where the amount of jolting calculated by the jolt amount calculation section 32 is equal to or less than the threshold set in advance, the jolt determination section 33 should determine that the body has not jolted. Here, as described above, as the amount of jolting, the amount of jolting in the advancing direction of the body is calculated based on the acceleration in the advancing direction of the body, the amount of jolting in the width direction of the body is calculated based on the acceleration in the width direction of the body, and the amount of jolting in the height direction of the body is calculated based on the acceleration in the height direction of the body. Accordingly, the jolt determination section 33 can determine whether the body has jolted or not individually in terms of each of the advancing direction of the body, the width direction of the body, and the height direction of the body. It is needless to say that the jolt determination section 33 may generally determine whether the body has jolted or not, based on respective amounts of jolting in the advancing direction of the body, the width direction of the body, and the height direction of the body.

In a case where the body is determined to have jolted, the jolt position estimation section 34 supplements position information associated with the acceleration information used for the determination of jolting with image information associated with the acceleration information and estimates a position where the body has jolted. As described above, the jolt determination section 33 determines whether the body has jolted or not. In a case where the jolt determination section 33 determines that the body has jolted, the jolt position estimation section 34 should acquire, from the jolt determination section 33, the acceleration information used for the determination that the body has jolted. It is needless to say that the jolt position estimation section 34 may acquire, from the jolt determination section 33, information indicative of the acceleration information used for the determination that the body has jolted (e.g., time information related to the acceleration information). The position information associated with the acceleration information used for the determination of jolting is position information associated with the acceleration information at the time when the acceleration information is stored in the storage section 31.

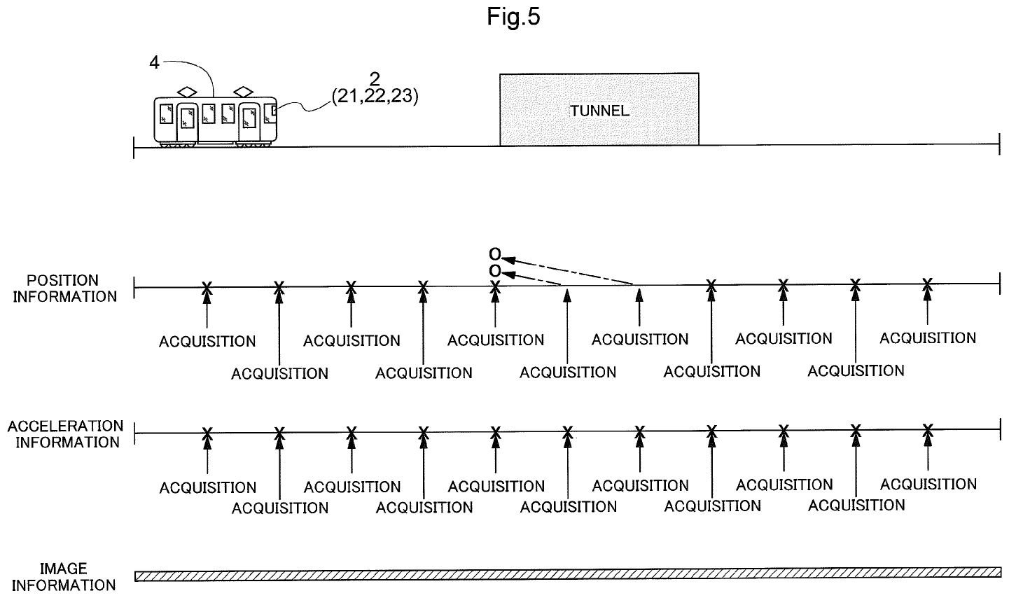

Here, position information acquired by the position information acquisition section 21 is acquired based on GPS signals, as mentioned earlier. However, in a place such as a place inside a tunnel or a place where the light is blocked by a mountain, for example, the position information acquisition section 21 cannot connect to GPS satellites and cannot acquire accurate GPS information, as illustrated in FIG. 5. That is, as illustrated in FIG. 5, acceleration information is also acquired inside a tunnel, but there is such a situation that the position of the electric train 4, indicated by position information, stays at a position (a position indicated by “O”) right before the electric train 4 enters the tunnel, even while the electric train 4 is running through the tunnel. In view of this, the jolt position estimation section 34 supplements position information associated with acceleration information with image information associated with the acceleration information.

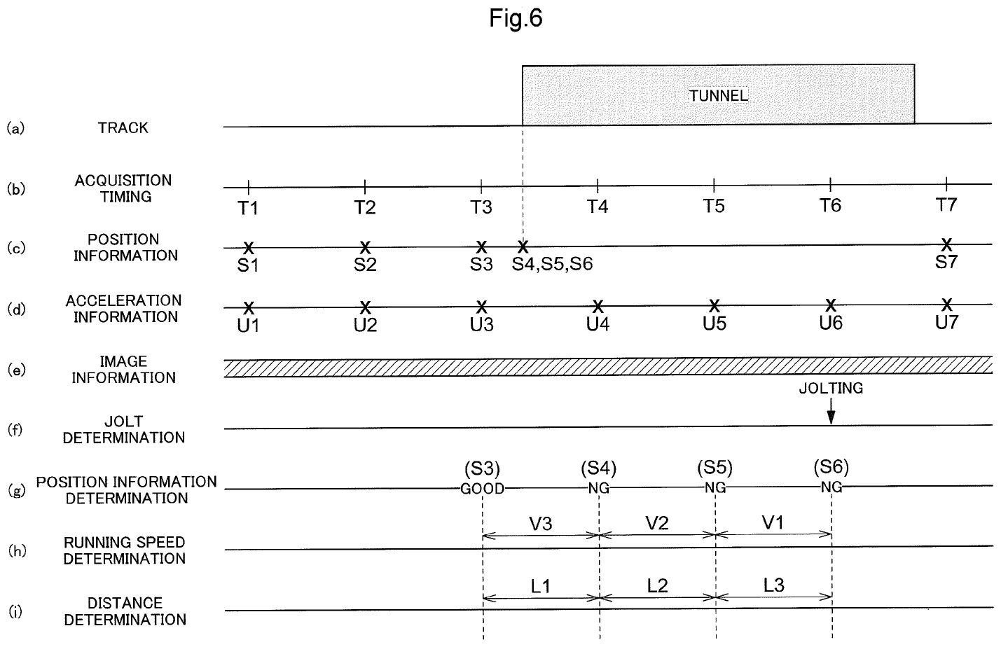

The following describes a method for supplementing position information with reference to an example. A track where the electric train 4 has run is illustrated in (a) of FIG. 6. In the example of (a) of FIG. 6, there is a tunnel in the middle of the track. Timings when position information and acceleration information are acquired are illustrated in (b) of FIG. 6. In the example of (b) of FIG. 6, T1, T2, T3, T4, T5, T6, T7 are illustrated as acquisition timings. In (c) of FIG. 6, a position (hereinafter referred to as “position information”) indicated by position information acquired at each of the timings is indicated by “X.” More specifically, position information acquired in T1 is S1, position information acquired in T2 is S2, position information acquired in T3 is S3, position information acquired in T4 is S4, position information acquired in T5 is S5, position information acquired in T6 is S6, and position information acquired in T7 is S7. Similarly, acceleration information acquired at each of the timings is indicated by “X” in (d) of FIG. 6. More specifically, acceleration information acquired in T1 is U1, acceleration information acquired in T2 is U2, acceleration information acquired in T3 is U3, acceleration information acquired in T4 is U4, acceleration information acquired in T5 is U5, acceleration information acquired in T6 is U6, and acceleration information acquired in T7 is U7. Further, in (e) of FIG. 6, the presence of image information constituted by a moving image captured continuously is indicated by hatching.

In a case where the jolt determination section 33 determines that the body has jolted, the position information determination section 35 determines whether position information associated with acceleration information is appropriate or not, based on image information associated with the position information and image information associated with previous position information acquired just before the position information. The position information determination section 35 should acquire a determination result from the jolt determination section 33 to specify whether the body has jolted or not. In the present embodiment, as illustrated in (f) of FIG. 6, it is determined that the body has jolted in T6, based on the acceleration information in T6.

Whether the position information associated with the acceleration information is appropriate or not is determined as follows. That is, for example, in a case where, although position information associated with acceleration information and previous position information acquired just before the position information indicate the same position (generally the same position), the position of a subject included in image information at the time when the position information associated with the acceleration information has been acquired is different from the position of the subject included in image information at the time when the previous position information has been acquired just before the position information, or in a case where the position information acquisition section 21 cannot acquire position information appropriately and has an error, it can be determined that the position information is not appropriate. That is, in a case where it is determined that the body has jolted in T6, it is determined whether the position information S6 acquired in T6 is appropriate or not. In the present embodiment, since the electric train 4 runs through the tunnel, the position information acquisition section 21 cannot acquire GPS signals from GPS satellites, and pieces of position information S4, S5, S6 in T4, T5, T6 exhibit the same position (the entrance of the tunnel), as illustrated in (c) of FIG. 6. In such a case, based on a state where the position information S5 in T5 and the position information S6 in T6 exhibit the same position, and a state where the position of the subject (e.g., the wall of the tunnel, pillars provided inside the tunnel, railroad ties on the railroad track, and so on) included in an image (frame) in T6 in the image information is different from the position of the subject included in an image (frame) in T5 in the image information, the position information determination section 35 determines that the position information does not change though the electric train 4 is running and therefore determines that the position information S6 in T6 is not appropriate. In (g) of FIG. 6, “NG” is exhibited to indicate that the position information S6 in T6 is determined not to be appropriate. The determination result made by the position information determination section 35 is transmitted to the most-recent position determination section 36 (described later). At this time, position information determined not to be appropriate or information (information indicative of an acquisition timing) that can specify the position information should be transmitted to the most-recent position determination section 36.

In a case where the position information determination section 35 determines that the position information is not appropriate, the most-recent position determination section 36 determines appropriate most recent position information before a first point at which the position information has been acquired, based on image information. In the example of FIG. 6, the position information determination section 35 determines that the position information S6 in T6 is not appropriate. In this case, T6 corresponds to the first point at which the position information S6 has been acquired. Accordingly, the most-recent position determination section 36 determines whether or not the position information S5 in T5 before T6 is appropriate or not. In this case, the determination should be made in a similar manner to the aforementioned determination made by the position information determination section 35. That is, the determination should be made based on whether or not there is a difference between the position information S5 in T5 and the position information S4 in T4 just before T5 and whether or not the difference corresponds to the difference between the position of the subject included in the image (frame) in T5 in the image information and the position of the subject included in an image (frame) in T4 in the image information. In the example of FIG. 6, the position information S4 in T4 and the position information S5 in T5 exhibit the same position, but the position of the subject included in the image (frame) in T4 in the image information is different from the position of the subject included in the image (frame) in T5 in the image information. Accordingly, since the position information S5 does not change from the position information S4 though the electric train 4 is running, the most-recent position determination section 36 determines that that the position information S5 in T5 is not appropriate. In (g) of FIG. 6, “NG” is exhibited to indicate that the position information S5 in T5 is determined not to be appropriate.

Subsequently, since the position information S5 in T5 is not appropriate, the most-recent position determination section 36 determines whether the position information S4 in T4 just before T5 is appropriate or not. That is, the determination is made based on whether or not there is a difference between the position information S4 in T4 and the position information S3 in T3 just before T4 and whether or not the difference corresponds to the difference between the position of the subject included in the image (frame) in T4 in the image information and the position of the subject included in an image (frame) in T3 in the image information. In the example of FIG. 6, since the electric train 4 runs by a predetermined distance after the position information S3 in T3 is acquired but before the entrance of the tunnel in which no GPS signal is acquired, it is assumed that the position information S3 in T3 and the position information S4 in T4 do not exhibit the same position. In the meantime, although the position of the subject included in the image (frame) in T3 in the image information is different from the position of the subject included in the image (frame) in T4 in the image information, the difference between the position information S3 in T3 and the position information S4 in T4 does not correspond to the moving amount (moving speed) of this subject, and therefore, the most-recent position determination section 36 determines that the position information S4 in T4 is not appropriate. In (g) of FIG. 6, “NG” is exhibited to indicate that the position information S4 in T4 is determined not to be appropriate.

Further, since the position information S4 in T4 is not appropriate, the most-recent position determination section 36 determines whether the position information S3 in T3 just before T4 is appropriate or not. That is, the determination is made based on whether or not there is a difference between the position information S3 in T3 and the position information S2 in T2 just before T3 and whether or not the difference corresponds to the difference between the position of the subject included in the image (frame) in T3 in the image information and the position of the subject included in an image (frame) in T2 in the image information. In the example of FIG. 6, GPS signals are received appropriately after the position information S2 in T2 is acquired but before the position information S3 in T3 is acquired. In the meantime, the position of the subject included in the image (frame) in T2 in the image information is different from the position of the subject included in the image (frame) in T3 in the image information, and the difference between the position information S2 in T2 and the position information S3 in T3 corresponds to the moving amount (moving speed) of this subject, and therefore, the most-recent position determination section 36 determines that the position information S3 in T3 is appropriate. In (g) of FIG. 6, “GOOD” is exhibited to indicate that the position information S3 in T3 is determined to be appropriate. Thus, the most-recent position determination section 36 specifies a point the position information of which is determined to be appropriate, by going back from a point the position information of which is determined not to be appropriate by the position information determination section 35.

Referring back to FIG. 1, the running speed calculation section 37 calculates the running speed of the body in a period during which two consecutive pieces of position information are acquired, the period being included in the period from the first point to a second point at which most recent position information has been acquired. The first point indicates a point at which the position information determined not to be appropriate by the position information determination section 35 has been acquired and corresponds to T6 in the present embodiment. That “most recent position information has been acquired” indicates that most recent position information determined to be appropriate by the most-recent position determination section 36 has been acquired. On this account, T3 corresponds to the “second point at which most recent position information has been acquired” in the present embodiment. Accordingly, the period from T6 to T5, the period from T5 to T4, and the period from T4 to T3, included in the period from T6 to T3 in FIG. 6, correspond to the “period during which two consecutive pieces of position information are acquired, the period being included in the period from the first point to the second point at which the most recent position information has been acquired.”

The running speed calculation section 37 calculates the moving speed of the subject based on the difference between the position of the subject included in the image (frame) in T6 in the image information and the position of the subject included in the image (frame) in T5 in the image information and the time difference between T5 and T6, and the moving speed is treated as the running speed of the body. At this time, the moving speed of the subject should be calculated in consideration of the position from the imaging section 23 to the subject and the angle of view of frames. In (h) of FIG. 6, V1 is exhibited as the running speed of the body from T5 to T6.

Similarly, the running speed calculation section 37 calculates the running speed of the body from T4 to T5 based on a moving speed of the subject, the moving speed being calculated based on the difference between the position of the subject included in the image (frame) in T5 in the image information and the position of the subject included in the image (frame) in T4 in the image information and the time difference between T4 and T5, and further, the running speed calculation section 37 calculates the running speed of the body from T3 to T4 based on a moving speed of the subject, the moving speed being calculated based on the difference between the position of the subject included in the image (frame) in T4 in the image information and the position of the subject included in the image (frame) in T3 in the image information and the time difference between T3 and T4. In (h) of FIG. 6, V2 is exhibited as the running speed of the body from T4 to T5, and V3 is exhibited as the running speed of the body from T3 to T4. Note that the running speed calculation section 37 may receive a running speed at every operation time stored in the electric train 4 and calculate an average value or the like by use of running speeds corresponding to acquisition timings of pieces of position information.

The jolt position estimation section 34 estimates a position of jolting determined to have occurred, based on the most recent position information determined to be appropriate and the running speeds. The most recent position information determined to be appropriate is position information determined to be appropriate by the most-recent position determination section 36 and is the position information S3 in T3. The running speeds are running speeds calculated by the running speed calculation section 37 and running speeds during the period from a point at which position information determined to be appropriate by the most-recent position determination section 36 has been acquired to a point at which position information determined not to be appropriate by the position information determination section 35 has been acquired. In the present embodiment, the running speeds correspond to the running speeds from T3 to T6. The jolt position estimation section 34 estimates the running distance of the electric train 4 from T3 to T4 based on the running speed from T3 to T4 and the time difference between T3 and T4. In (i) of FIG. 6, the running distance of the electric train 4 from T3 to T4 is indicated by L1.

Similarly, the jolt position estimation section 34 calculates the running distance of the electric train 4 from T4 to T5 based on the running speed from T4 to T5 and the time difference between T4 and T5 and calculates the running distance of the electric train 4 from T5 to T6 based on the running speed from T5 to T6 and the time difference between T5 and T6. In (i) of FIG. 6, the running distance of the electric train 4 from T4 to T5 is indicated by L2, and the running distance of the electric train 4 from T5 to T6 is indicated by L3.

The jolt position estimation section 34 calculates a point moved from the position information S3 in T3 only by the sum of L1, L2, and L3 along the railroad track of the electric train 4 and estimates this point as the position of jolting determined to have occurred. Thus, with the train jolt determination system 1, even in a case where position information is not appropriate, it is possible to estimate the position of a point where the body has jolted.

As described above, by holding the portable terminal 2 in the electric train 4, it is possible to acquire position information, acceleration information, and image information on the electric train 4 easily at a low cost. Accordingly, when respective portable terminals 2 are held pin the plurality of electric trains 4 configured to run along the same track in different time ranges, it is possible to acquire a plurality of pieces of position information, a plurality of pieces of acceleration information, and a plurality of pieces of image information along the same track.

In this case, the train jolt determination system 1 should determine whether jolting has occurred or not, based on the pieces of position information, the pieces of acceleration information, and the pieces of image information acquired from the plurality of electric trains 4. Further, in such a plurality of determinations, in a case where a smaller amount of jolting than a value set in advance is detected only a preset number of times in a predetermined range including a position estimated by the jolt position estimation section 34 in response to the jolt determination section 33 determining that jolting has occurred, the cancellation section 41 should cancel a determination result indicating that the body has jolted, the determination result being made by the jolt determination section 33. The predetermined range including the position estimated by the jolt position estimation section 34 is a range set to include a position estimated, as the position where jolting has occurred, by the jolt position estimation section 34 in response to the jolt determination section 33 determining that jolting has occurred. This range should be set based on a distance by which the electric train 4 can run between two timings at each of which position information is acquired, for example.

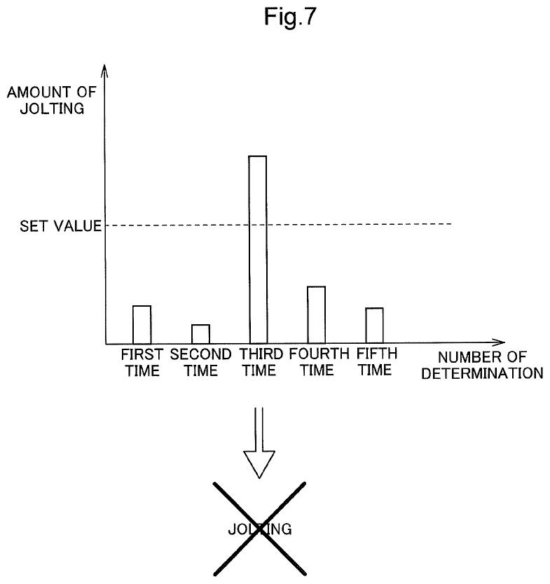

FIG. 7 illustrates the amount of jolting calculated based on information from each of the plurality of electric trains 4 in the predetermined range including the position for which the jolt determination section 33 determines that the body has jolted. In FIG. 7, the lateral axis indicates the number of times of determination, and the vertical axis indicates the amount of jolting. In the example of FIG. 7, the “value set in advance” is illustrated as a “set value,” and in the third determination, the amount of jolting exceeding the set value is calculated, so that the jolt determination section 33 has determined that jolting has occurred.

In this case, the cancellation section 41 refers to the amount of jolting calculated in the predetermined range including the position where jolting has occurred, in the third determination. In the present embodiment, respective amounts of jolting in the first determination, the second determination, the fourth determination, and the fifth determination are listed. In the example of FIG. 7, since a smaller amount of jolting than the set value is detected only a preset number of times (e.g., four times), the amount of jolting in the third determination is more likely to be false detection obtained in a place with the largest curvature in a curved area, for example. In view of this, the cancellation section 41 should cancel the determination result in the third determination, indicating that jolting has occurred. This makes it possible to prevent confirmation or maintenance from being performed due to the false detection.

Further, with the train jolt determination system 1, in a case where the determination on whether jolting has occurred or not is made based on the pieces of position information, the pieces of acceleration information, and the pieces of image information acquired from the plurality of electric trains 4, it is possible for the maintenance timing calculation section 42 to calculate a maintenance timing for running equipment. The running equipment corresponds to a device provided in the body of the electric train 4 and track equipment constituted by tracks on which the electric train 4 runs and equipment provided on the tracks. The device provided in the body of the electric train 4 includes, for example, a chassis, wheels, a wagon, and so on, and the track equipment is not limited to rails, for example, and also includes railroad ties, ballast, concrete to which rails are fixed, points, trees and plants beside rails, and so on, for example. For example, when the electric train 4 repeatedly runs after its body and the track equipment are prepared, the body and the track equipment gradually deteriorate, and this may cause jolting. In view of this, the maintenance timing calculation section 42 should calculate a future maintenance timing as described above.

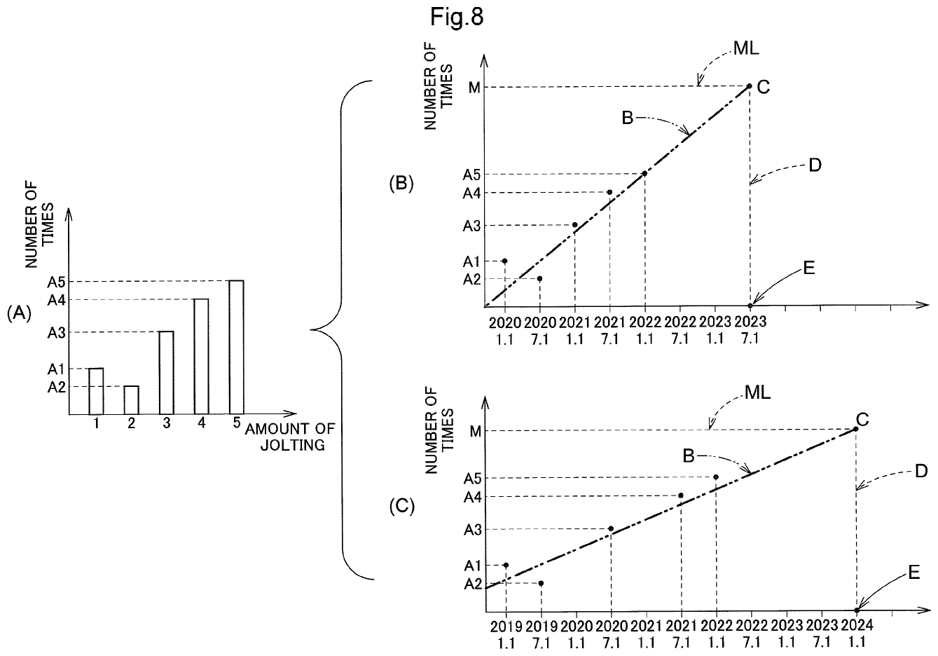

The amount of jolting at each time of calculation of the amount of jolting is illustrated in (A) of FIG. 8. In the present embodiment, the amounts of jolting from the first time to the fifth time are illustrated such that the amount of jolting in the first time is indicated by A1, the amount of jolting in the second time is indicated by A2, the amount of jolting in the third time is indicated by A3, the amount of jolting in the fourth time is indicated by A4, and the amount of jolting in the fifth time is indicated by A5. From (A) of FIG. 8, it is found that, as the number of times of calculation increases, the amount of jolting has an increase tendency to gradually increase. However, the running of the electric train 4 equipped with the portable terminal 2 as stated above may be performed regularly or may be performed irregularly (at irregular intervals). Accordingly, from the chart of (A) of FIG. 8, the maintenance timing calculation section 42 can evaluate the increase tendency qualitatively but cannot evaluate the increase tendency quantitatively.

In view of this, the maintenance timing calculation section 42 creates a chart indicative of the relationship between the date and time of acquisition of acceleration information and the amount of jolting as illustrated in (B) of FIG. 8, based on date-and-time information on acceleration information used for calculation of the amount of jolting at every time. In (B) of FIG. 8, the date of acquisition of acceleration information used for calculation of the amount of jolting in the first time is Jan. 1, 2020, the date of acquisition of acceleration information used for calculation of the amount of jolting in the second time is Jul. 1, 2020, the date of acquisition of acceleration information used for calculation of the amount of jolting in the third time is Jan. 1, 2021, the date of acquisition of acceleration information used for calculation of the amount of jolting in the fourth time is Jul. 1, 2021, and the date of acquisition of acceleration information used for calculation of the amount of jolting in the fifth time is Jan. 1, 2022. The maintenance timing calculation section 42 draws an approximate line B based on plots in (B) of FIG. 8.

In the meantime, a maintenance value M is set in advance as an index indicative of the necessity of maintenance when the amount of jolting is equal to or higher than a predetermined value, and the maintenance timing calculation section 42 calculates a point where the approximate line B reaches the maintenance value M, that is, an intersection C of a maintenance line ML indicative of the maintenance value M with the approximate line B. Subsequently, the maintenance timing calculation section 42 draws a perpendicular line D passing through the intersection C and perpendicular to the lateral axis and finds an intersection E of the lateral axis with the perpendicular line D. The maintenance timing calculation section 42 calculates a maintenance timing as a predicted value based on time information at the intersection E. In the example in (B) of FIG. 8, the intersection E indicates Jul. 1, 2023, and therefore, the maintenance timing calculation section 42 determines Jul. 1, 2023 as a next maintenance timing.

In the meantime, (C) of FIG. 8 illustrates an example in which date-and-time information on acceleration information used for calculation of the amount of jolting is different from that in the example of (B) of FIG. 8. In (C) of FIG. 8, the date of acquisition of acceleration information used for calculation of the amount of jolting in the first time is Jan. 1, 2019, the date of acquisition of acceleration information used for calculation of the amount of jolting in the second time is Jul. 1, 2019, the date of acquisition of acceleration information used for calculation of the amount of jolting in the third time is Jul. 1, 2020, the date of acquisition of acceleration information used for calculation of the amount of jolting in the fourth time is Jul. 1, 2021, and the date of acquisition of acceleration information used for calculation of the amount of jolting in the fifth time is Jan. 1, 2022. The maintenance timing calculation section 42 draws an approximate line B based on plots illustrated in (C) of FIG. 8.

Subsequently, the maintenance timing calculation section 42 calculates an intersection C of the maintenance line ML indicative of the maintenance value M with the approximate line B. Then, the maintenance timing calculation section 42 draws a perpendicular line D passing through the intersection C and perpendicular to the lateral axis and finds an intersection E of the lateral axis with the perpendicular line D. The maintenance timing calculation section 42 calculates a maintenance timing as a predicted value based on time information at the intersection E. In the example in (C) of FIG. 8, the intersection E indicates Jan. 1, 2024, and therefore, the maintenance timing calculation section 42 determines Jan. 1, 2024 as a next maintenance timing.

Thus, in a case where the amount of jolting of the body in the predetermined range including the position estimated by the jolt position estimation section 34 has an increase tendency to increase gradually, the maintenance timing calculation section 42 calculates the next maintenance timing of the running equipment in the predetermined range based on the degree of increase in the amount of jolting (a gradient by which the amount of jolting increases in (B) or (C) in FIG. 8).

Here, the train jolt determination system 1 can be configured to estimate a factor that has caused jolting and exhibit the factor. In this case, first, the jolt factor estimation section 51 estimates a factor that has caused jolting from image information including the scene at a position determined as the position where the body has jolted. The position determined as the position where the body has jolted is estimated by the jolt position estimation section 34. Based on time information on acceleration information used for the determination of jolting, the jolt factor estimation section 51 extracts, from image information associated with the acceleration information, an image including the scene at the position (location) where the electric train 4 has run around the time indicated by the time information. From the image thus extracted, the jolt factor estimation section 51 estimates a factor that has caused jolting by use of image recognition by AI (artificial intelligence), for example. For example, the estimation by the image recognition should be machine learning with training data in which at least either of an image including a factor causing jolting and an image including no factor causing jolting is stored in advance, and an extracted image is compared with the image thus stored in advance.

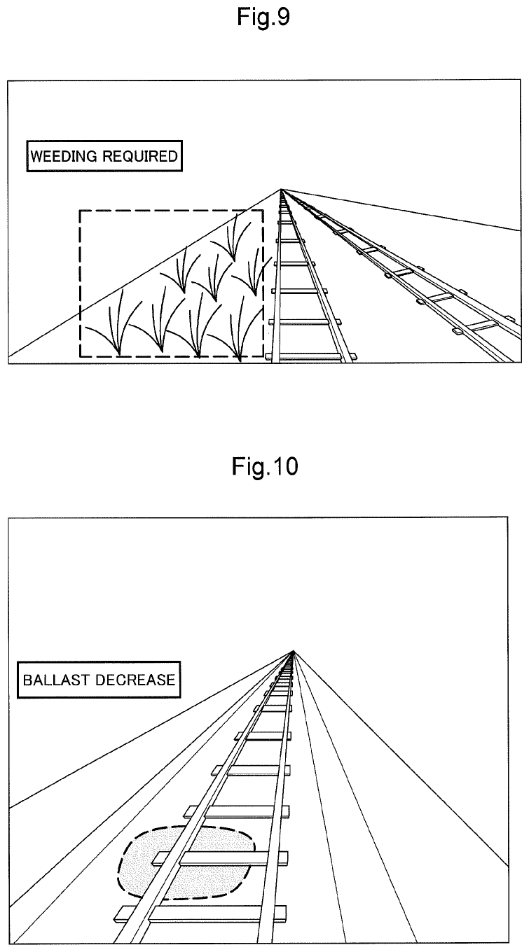

FIG. 9 illustrates an example of a case where grasses invade and grow in a range where the body passes at the time of running of the electric train 4. As described above, the jolt factor estimation section 51 is caused to mechanically learn, in advance, images of grasses and the range where the body passes, so that the jolt factor estimation section 51 can specify a situation as illustrated in FIG. 9 from an extracted image and estimate a factor that has caused jolting.

Further, FIG. 10 illustrates an example of a case where ballast placed in a railroad track decreases from a specified amount. When the ballast decreases or increases, the color of a corresponding part (a ballast-decreasing part or a ballast-increasing part) in an extracted image is different from the color of parts with a specified amount of ballast. In view of this, as described above, the jolt factor estimation section 51 is caused to mechanically learn images of an appropriate amount of ballast, so that the jolt factor estimation section 51 can specify a situation as illustrated in FIG. 10 from the extracted image and estimate a factor that has caused jolting. It is needless to say that, the jolt factor estimation section 51 may be configured to mechanically learn images of cases where the amount of ballast is smaller than the specified amount or images of cases where the amount of ballast is larger than the specified amount and to estimate a factor that has caused jolting. Such an estimated result from the jolt factor estimation section 51 is transmitted to the notification section 52 (described later).

Further, the jolt factor estimation section 51 may determine, based on time information on acceleration information used for the determination of jolting, whether or not abnormal noise has occurred by referring to image information including the scene at a position (location) where the electric train 4 has run at the time indicated by the time information, out of image information associated with the acceleration information, and when abnormal noise has occurred, the jolt factor estimation section 51 can estimate a factor that has caused jolting based on the abnormal noise.

Further, the jolt factor estimation section 51 may be configured as follows. That is, the jolt factor estimation section 51 calculates, based on time information on acceleration information used for the determination of jolting, the curvature (or the curvature radius) of a part provided with rails including a position (location) where the electric train 4 has run around the time indicated by the time information, by referring to image information including the scene at the position, out of image information associated with the acceleration information. In a case where the curvature is larger than a predetermined amount (the curvature radius is smaller than a predetermined amount), the jolt factor estimation section 51 determines that jolting has occurred due to a sharp curve, and deletes (cancels) a determination result from the jolt determination section 33, the determination result indicating that jolting has occurred.

For example, in a case where the electric train 4 passes an oncoming vehicle at the time of running, the body may jolt due to a wind (wind pressure) caused by the passing. In view of this, the jolt factor estimation section 51 may be configured as follows. That is, in a case where, based on time information on acceleration information used for the determination of jolting, an oncoming vehicle is included in image information associated with the acceleration information, the jolt factor estimation section 51 determines that the body has jolted due to the passing of the vehicles (due to a wind pressure caused by the passing) and deletes (cancels) a determination result from the jolt determination section 33, the determination result indicating that jolting has occurred.

The notification section 52 exhibits the factor estimated by the jolt factor estimation section 51 in the image information. As described above, the factor thus estimated by the jolt factor estimation section 51 is transmitted from the jolt factor estimation section 51 as an estimated result. The notification section 52 exhibits, to a user (a train driver or a train supervisor), a corresponding part estimated as the factor that has caused jolting by marking the corresponding part, for example, on a display device (e.g., the portable terminal 2 or a train management apparatus) that can display image information.

In the example of FIG. 9, since the invasion of grasses in the range where the body passes at the time of running of the electric train 4 is estimated as the factor that has caused jolting, a part corresponding to the “grasses” as a target of the factor is surrounded by a broken line to be exhibited. Further, in addition, measures to prevent the occurrence of jolting, that is, in the example of FIG. 9, the text “weeding required,” for example, should be displayed on a display screen to promote weeding.

Further, in the example of FIG. 10, since the decrease in the amount of ballast from the specified amount is estimated as the factor, a “part where the amount of ballast is smaller than the specified amount,” as a target of the factor, is surrounded by a broken line to be exhibited. Further, in addition, as the factor that has caused jolting, the text “ballast decrease” should be displayed to exhibit, on the display screen, that the amount of ballast is small, for example. Hereby, it is possible to exhibit the occurrence of jolting due to a poor track state and to promote maintenance.

Note that the notification section 52 may be configured as follow. That is, the notification section 52 displays, on the display screen, a list of areas where jolting occurs, for example, and when the user selects an area from the list, the notification section 52 displays an image of a factor that has caused jolting in the selected area to exhibit the factor.

### Other Embodiments

The above embodiment describes an example in which the position information acquisition section 21, the acceleration sensor 22, and the imaging section 23 are provided in the portable terminal 2 such as a smartphone and the portable terminal 2 is held in the electric train 4. However, the portable terminal 2 may be a tablet terminal or a laptop computer.

The above embodiment describes an example in which the position information acquisition section 21 acquires position information indicative of the position of the electric train 4 based on GPS signals. However, the position information acquisition section 21 can be configured to include a navigation system, for example, and to acquire position information by autonomous navigation in a case where the position information acquisition section 21 cannot receive GPS signals.

The above embodiment describes an example in which the jolt amount calculation section 32 calculates the amount of jolting in the advancing direction of the body based on the acceleration in the advancing direction of the body, calculates the amount of jolting in the width direction of the body based on the acceleration in the width direction of the body, and calculates the amount of jolting in the height direction of the body based on the acceleration in the height direction of the body. However, the jolt amount calculation section 32 can be configured to calculate at least any one of the amount of jolting in the advancing direction of the body, the amount of jolting in the width direction of the body, and the amount of jolting in the height direction of the body.

The above embodiment describes an example in which, in a case where it is determined that jolting has occurred and position information associated with acceleration information used for the determination of jolting is determined not to be appropriate, the jolt position estimation section 34 estimates a position of jolting determined to have occurred, based on most recent position information determined to be appropriate and a running speed calculated by the running speed calculation section 37. However, the jolt position estimation section 34 can be configured to estimate a position of jolting determined to have occurred, based on most recent position information determined to be appropriate and a running distance calculated by autonomous navigation.

The above embodiment describes an example in which, in a case where a smaller amount of jolting than the value set in advance is detected a preset number of times in a predetermined range including a position estimated by the jolt position estimation section 34, the cancellation section 41 cancels a determination result made by the jolt determination section 33, the determination result indicating that the body has jolted. However, the train jolt determination system 1 can be configured to include no cancellation section 41.

The above embodiment describes an example in which, in a case where the amount of jolting of the body in a predetermined range including a position estimated by the jolt position estimation section 34 has an increase tendency to increase gradually, the maintenance timing calculation section 42 calculates a maintenance timing of the running equipment in the predetermined range based on the degree of increase in the amount of jolting. However, the train jolt determination system 1 can be configured to include no maintenance timing calculation section 42. Further, the train jolt determination system 1 can be configured to, in a case where the amount of jolting of the body in the predetermined range including the position estimated by the jolt position estimation section 34 has an increase tendency to increase gradually, estimate a breakdown timing of the running equipment to break down in the predetermined range based on the degree of increase in the amount of jolting.

The above embodiment describes an example in which, in a case where the position information determination section 35 determines that position information is not appropriate, the most-recent position determination section 36 determines, based on image information, appropriate most recent position information before the first point at which the position information determined not to be appropriate has been acquired. However, in a case where the position information determination section 35 determines that position information is not appropriate, the most-recent position determination section 36 can be configured to determine, based on acceleration information, most recent appropriate position information before the first point at which the position information determined not to be appropriate has been acquired. In this case, for example, the most-recent position determination section 36 may find the running speed of the body by integrating acceleration information indicative of a detection result of the acceleration along the advancing direction of the body (the acceleration along the Z-axis in FIG. 2) and determine appropriate most recent position information before the first point by use of the running speed. It is needless to say that the most-recent position determination section 36 can be configured to, in a case where the position information determination section 35 determines that position information is not appropriate, determine, based on both the image information and the acceleration information, appropriate most recent position information before the first point at which the position information determined not to be appropriate has acquired.

The above embodiment describes an example in which the running speed calculation section 37 calculates the moving speed of the subject based on the difference between the position of the subject included in an image (frame) at a predetermined point (e.g., T6 in FIG. 6) in image information and the position of the subject included in an image (frame) at another point (e.g., T5 in FIG. 6) in the image information and the time difference between these two points (the time difference between T5 and T6), and the moving speed of the subject is treated as the running speed of the body. However, the running speed calculation section 37 can find the running speed of the body by integrating acceleration information indicative of a detection result of the acceleration along the advancing direction of the body (the acceleration along the Z-axis in FIG. 2), for example.

The above embodiment describes an example in which the jolt factor estimation section 51 estimates a factor that has caused jolting from image information including the scene at a position determined as the position where the body has jolted. However, the train jolt determination system 1 can be configured to include no jolt factor estimation section 51.

This disclosure can be used for a train jolt determination system for determining the jolting of a train.

What is claimed is:

1. A train jolt determination system for determining jolting of a train, the train jolt determination system comprising:
a portable terminal capable of being held in the train and including at least a position information acquisition section configured to acquire position information indicative of a position of the train, an acceleration sensor configured to detect an acceleration caused in a body of the train, and an imaging section configured to capture an image of a scene around the train;
a storage section configured to associate, with each other, the position information, acceleration information indicative of a detection result of the acceleration, and image information indicative of the scene around the train and store the position information, the acceleration information, and the image information;
a jolt amount calculation section configured to calculate an amount of jolting of the body based on the acceleration information;
a jolt determination section configured to determine, based on the amount of jolting, whether or not the body has jolted; and
a jolt position estimation section configured to, in response to the jolt determination section determining that jolting has occurred, supplement position information associated with acceleration information used for the determination of jolting with image information associated with the acceleration information and estimate a position where the body has jolted.

2. The train jolt determination system according to claim 1, further comprising:
a position information determination section configured to, in response to the jolt determination section determining that jolting has occurred, determine whether the position information associated with the acceleration information used for the determination of jolting is appropriate or not, based on the image information associated with the position information and image information associated with previous position information acquired just before the position information;
a most-recent position determination section configured to, in response to the position information being determined not to be appropriate, determine appropriate most recent position information before a first point at which the position information determined not to be appropriate has been acquired, based on at least either of the image information and the acceleration information; and
a running speed calculation section configured to calculate a running speed of the body in a period during which two consecutive pieces of position information are acquired, the period being included in a period from the first point to a second point at which the most recent position information has been acquired, wherein:
the jolt position estimation section estimates a position of the jolting determined to have occurred by the jolt determination section, based on the most recent position information determined to be appropriate and the running speed.

3. The train jolt determination system according to claim 1, further comprising:
a cancellation section configured to, in a case of the jolt determination section determining whether or not jolting has occurred by use of pieces of position information, pieces of acceleration information, and pieces of image information acquired from a plurality of trains, cancel a determination result made by the jolt determination section to indicate the occurrence of jolting in the body, in response to a smaller amount of jolting than a preset value being detected only a preset number of times in a predetermined range including the position estimated by the jolt position estimation section.

4. The train jolt determination system according to claim 2, further comprising:
a cancellation section configured to, in a case of the jolt determination section determining whether or not jolting has occurred by use of pieces of position information, pieces of acceleration information, and pieces of image information acquired from a plurality of trains, cancel a determination result made by the jolt determination section to indicate the occurrence of jolting in the body, in response to a smaller amount of jolting than a preset value being detected only a preset number of times in a predetermined range including the position estimated by the jolt position estimation section.

5. The train jolt determination system according to claim 1, further comprising:
a maintenance timing calculation section configured to, in a case of the jolt determination section determining whether or not jolting has occurred by use of pieces of position information, pieces of acceleration information, and pieces of image information acquired from a plurality of trains, calculate, based on degree of increase in the amount of jolting, a maintenance timing of running equipment in a predetermined range including the position estimated by the jolt position estimation section, in response to the amount of jolting of the body having an increase tendency to increase gradually in the predetermined range.

6. The train jolt determination system according to claim 2, further comprising:
a maintenance timing calculation section configured to, in a case of the jolt determination section determining whether or not jolting has occurred by use of pieces of position information, pieces of acceleration information, and pieces of image information acquired from a plurality of trains, calculate, based on degree of increase in the amount of jolting, a maintenance timing of running equipment in a predetermined range including the position estimated by the jolt position estimation section, in response to the amount of jolting of the body having an increase tendency to increase gradually in the predetermined range.

7. The train jolt determination system according to claim 1, further comprising:
a jolt factor estimation section configured to estimate a factor that has caused jolting in the body to jolt from image information including a scene at a position of the jolting determined to have occurred in the body by the jolt determination section; and
a notification section configured to exhibit the factor estimated by the jolt factor estimation section in the image information.

8. The train jolt determination system according to claim 2, further comprising:
a jolt factor estimation section configured to estimate a factor that has caused jolting in the body to jolt image information including a scene at a position of the jolting determined to have occurred in the body by the jolt determination section; and
a notification section configured to exhibit the factor estimated by the jolt factor estimation section in the image information.
